(19) United States
(12) Patent Application Publication
(10) Pub. No.: US 2007/0257684 A1
(43) Pub. Date: Nov. 8, 2007

(54) Monitor for Evaluating Changes in Water Quality

(76) Inventor: Eberhard Essich, Cleveland, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/737,329

(22) Filed: Apr. 19, 2007

Related U.S. Application Data
(60) Provisional application No. 60/793,367, filed on Apr. 20, 2006.

(51) Int. Cl. G08B 21/00

(52) U.S. Cl. 324/649; 340/603

(57) ABSTRACT

Included is a device for monitoring a test material. The device can include a probe configured for introduction to the test material. The probe can include a first electrode and a second electrode, where the first electrode can be positioned a predetermined distance from the second electrode. The device can also include a power source configured to provide a current to the probe. Additionally, the device can include a first data indicator and a potentiometer.

### CROSS REFERENCE

This application claims the benefit of U.S. Provisional Application No. 60/793,367, filed Apr. 20, 2006, which is hereby incorporated by reference in its entirety.

### TECHNICAL FIELD

This disclosure relates to detecting the presence or absence of water, and detecting water quality changes in mineral, metal, or ion content as may be determined by changes in resistance or conductivity of the water.

### BACKGROUND

Well owners, farmers, homeowners and other private citizens generally have no way of monitoring their water quality simply and inexpensively on a day-to-day basis. Many contaminants in water, even the most harmful contaminants, are tasteless, odorless, colorless, and otherwise undetectable by human senses. Occasionally, substances are inadvertently added to the water supply and the possibility of terrorist attacks via the water supply is increasing. Well water may be subject to intermittent saltwater intrusion, and can be influenced by other nearby water sources in unexpected ways. Generally speaking, many purification devices do not have integral water quality monitors. Additionally, the purification devices typically have no option for determining the results independently from the purification unit. Currently, the owner has no simple and convenient way to determine product water quality.

Pure water has very little electrical conductivity. However, impurities such as dissolved minerals, metals, and other ions make water more conductive. Generally, the level of conductivity is proportional to the amount of contamination in the water. Meters that are capable of measuring electrical resistance or conductivity typically have very sophisticated devices for measuring dissolved solids in water based on the electrical conductivity or resistivity of that water. These devices however, can be expensive, complicated, and difficult for the uninitiated to use properly. Voltage-ohm meters typically lack design components that would make them useful as water quality monitoring devices.

As a non-limiting example, resistance of water can be measured using a voltage-ohmmeter (VOM). However, inter-electrode distance can dramatically affect results when the resistance of water is measured at low ion concentrations. Since inter-electrode (probe) distance of a VOM is typically not fixed at a meaningful value, using a VOM to determine conductivity of aqueous solutions can be a poor means to obtain consistent results. In addition, even if consistent resistance or conductivity readings could be obtained, the meaning of those readings can be obscure to a user without a computer program, calculator program, graph, chart, or plot. Oftentimes the user is asked to convert the received data to corresponding values of total dissolved solids or ion concentrations in that aqueous solution using a specific probe type, inter-probe distance, etc.

Many contaminants alter the conductivity of a test material, such as water. Arsenic, mercury, zinc, copper, lead, sulfate, calcium, magnesium, sodium, manganese, potassium, chloride, and others are among these. Any significant change in conductivity of the test material can indicate changes in the concentration of contaminants in the material tested. This can be taken as an indication that water quality has changed and alert the users to that change. Having been alerted to such a change, the user may decide on an appropriate course of action.

Many currently used water quality meters can require calibration and standard solutions (special reagents), and the results can be difficult for the average person to decipher. These devices can contain complicated electronic circuitry and probes (electrodes) that are easily damaged by accident or misuse and are too expensive for use in citizen-based monitoring activities of household, well, natural, or other water supplies, or water distribution systems. Most of the currently used water monitoring devices are physically incorporated into some water purification systems to determine whether or not those systems are functioning within certain pre-determined parameters. These devices typically cannot be used elsewhere nor are they adaptable for other uses.

Additionally, existing water purification devices typically do not provide data (numerical values) that can be used to compare one water supply to another. Since the typical water quality meter is fixed in a water purification system, it generally cannot be removed to prevent damage during lightning storms and other natural events. Further, these devices typically cannot provide independent verification of the accuracy of the results or the reliability of the system.

Thus, a heretofore unaddressed need exists in the industry to address the aforementioned deficiencies and inadequacies.

### SUMMARY

Included in this disclosure are systems and methods for monitoring a test material. At least one non-limiting embodiment of a device for monitoring a test material includes a probe configured for introduction to the test material. The probe includes a first electrode and a second electrode, the first electrode being positioned a predetermined distance from the second electrode. A power source configured to provide a current to the probe is also included in the device, as well as a first data indicator configured to communicate data related to at least one electrical property of the test material to a user. This non-limiting example also includes a potentiometer configured with a user input device. The user input device is configured to facilitate adjustment of the potentiometer in response to receiving data from the first data indicator.

This disclosure also provides a method for testing the purity of a test material. At least one embodiment of the method includes introducing a probe to the test material. The probe in this embodiment includes a first electrode and a second electrode the first and second electrodes separated by a predetermined distance. This method also includes facilitating the introduction of an electrical current to the probe, and receiving first data related to at least one electrical property of test material. This method also includes receiving second data related to at least one electrical property of the test material, and adjusting at least one electrical property of a potentiometer, wherein the potentiometer is coupled to the probe until the second data roughly equals the first data. Finally, this nonlimiting example includes determining at least one electrical property of the test material.

Also included in this disclosure is a system for determining impurities in a test material. In at least one embodiment, the system includes an electrical property collector configured to receive at least one electrical property related to the test material. Additionally included in this embodiment is a first data indicator configured to provide a user with at least a portion of the data received from the electrical property collector and a second data indicator. The system also includes an impurity input device coupled to the second data indicator, the impurity input device configured to adjust data provided by the second data indicator via a user input. This embodiment also includes an impurity output device coupled to the impurity input device. The impurity output device is typically configured to display data related to at least one impurity in the test material.

Other systems, methods, features and/or advantages will be or may become apparent to one with skill in the art upon examination of the following drawings and detailed description. It is intended that all such additional systems, methods, features and/or advantages be included within the scope of the present disclosure and be protected by the accompanying claims.

### BRIEF DESCRIPTION

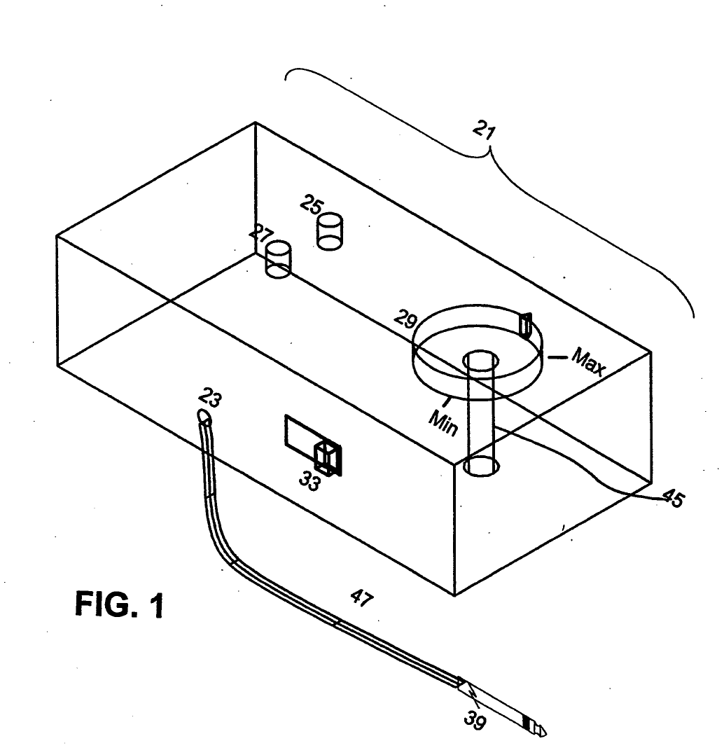

FIG. 1 is a perspective view of one embodiment of a water purification unit pursuant to the present disclosure.

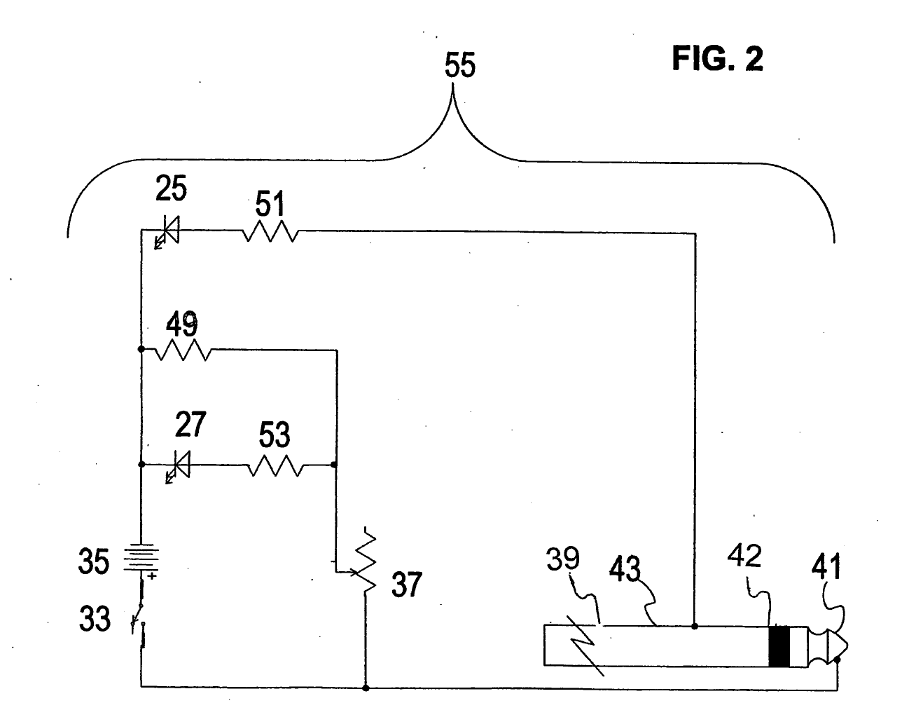

FIG. 2 is an exemplary circuit diagram illustrating one embodiment of logic that may be incorporated with the water purification unit from FIG. 1.

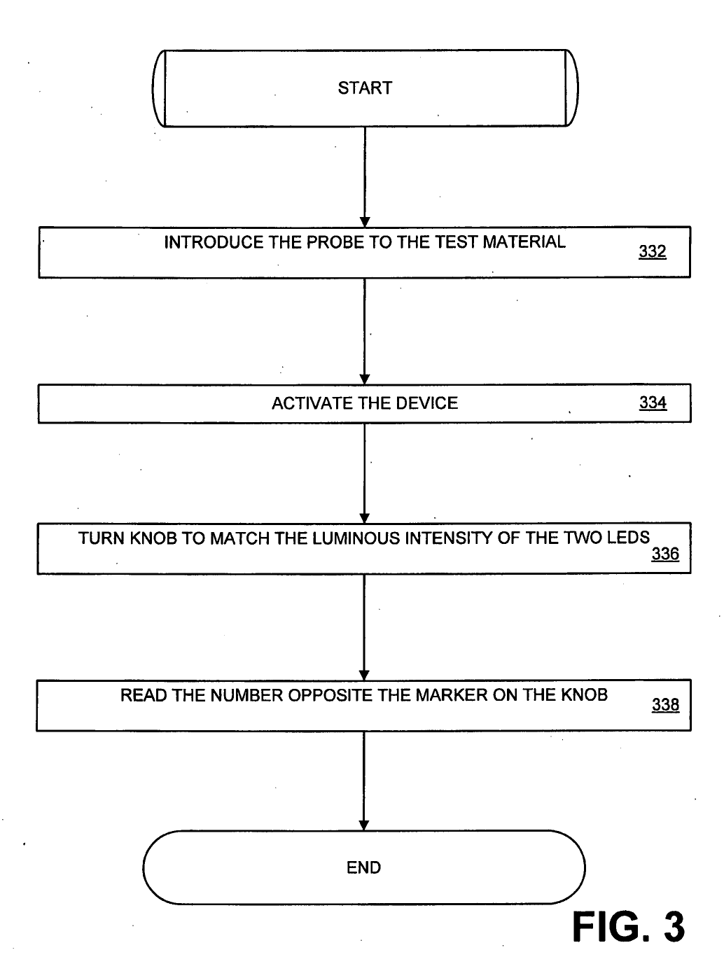

FIG. 3 is an exemplary flowchart diagram illustrating a process that a user may take in operating the device from FIG. 1.

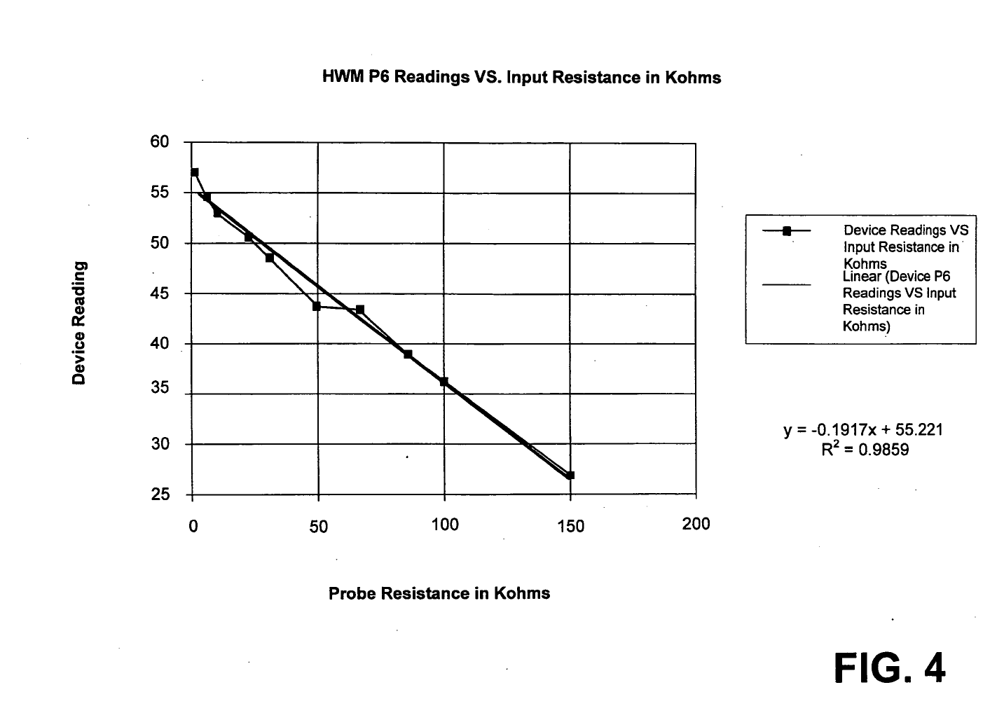

FIG. 4 is a graphical diagram describing an embodiment of a relationship between the reading on the water purification system and the resistance across the probe of the water purification system from FIG. 1.

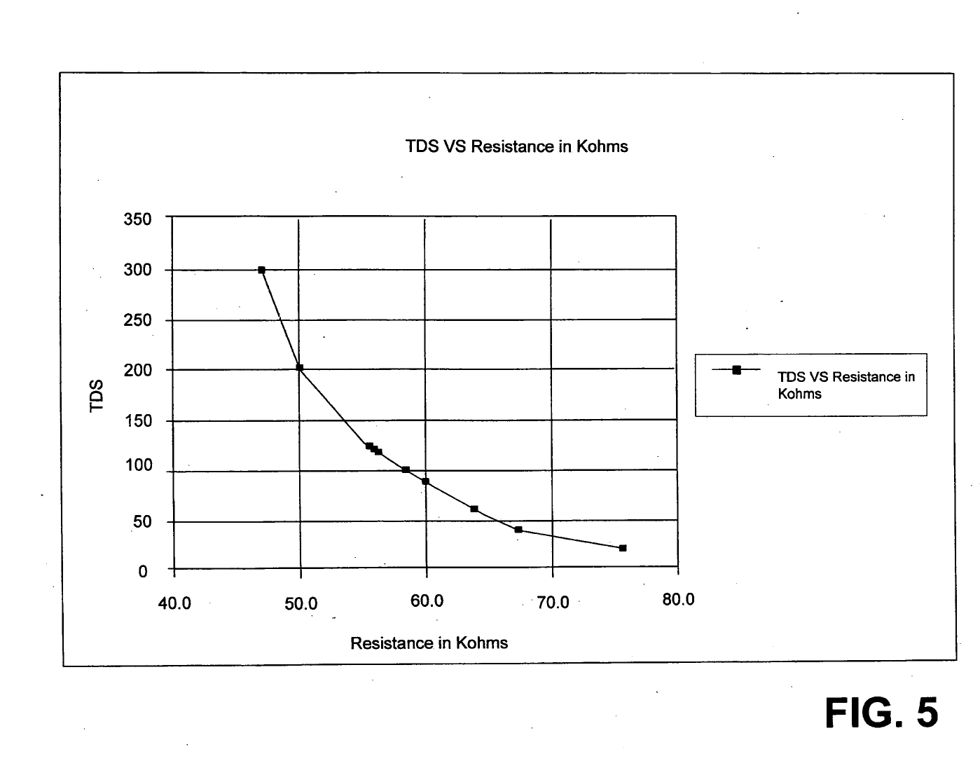

FIG. 5 is a graphical diagram illustrating a relationship between Total Dissolved Solids (TDS) and resistance of a sample, similar to the diagram from FIG. 4.

### DETAILED DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

Referring more specifically to the drawings in which like reference numerals refer to like elements throughout the several views, and exemplary non-limiting embodiments of the device and method of the present disclosure are illustrated in FIGS. 1-3.

FIG. 1 is a perspective view of an exemplary embodiment of a water purification determination device 21 pursuant to the present disclosure. As illustrated, the water purification determination device 21 can take the form of a handheld battery-operated unit. Included in the representation of FIG. 1 is a power switch 33, with which a user can activate and deactivate the device 21. Additionally, the device 21 includes a probe data indicator 25 and an adjustable data indicator 27. The data indicators 25, 27 can be configured to indicate various conductivity measurements to a user. Additionally, the water purification detection device 21 includes a potentiometer shaft 45 (that is coupled to a potentiometer) and a potentiometer knob (or impurity output device) 29. Further, the water purification detection device 21 may include an opening 23 in the body of the device configured to receive a probe wire 47 that is coupled to a probe jack 39.

As illustrated in FIG. 1, embodiments of the device 21 may include a potentiometer knob 29 mounted in the top panel of the case. The potentiometer knob 29 can be coupled to the shaft 45 of a potentiometer 37 (see FIG. 2). Around the potentiometer knob 29, on the top panel are etched, engraved, printed, or otherwise affixed symbols arranged in a circular pattern and in such a fashion as to be legible when the pointer indicates the numerals, illustrated “Max” and “Min” in FIG. 1. Additionally, in at least one exemplary embodiment a calibrated dial can be configured to provide the user with information related to the test material.

Additionally, the device 21 can include an enclosure that may be constructed of non-conductive material containing two light emitting diode's (LED) that act as data indicators 25, 27 mounted in a top panel (surface) and visible to a user. These LEDs may be recessed against a contrasting background, such as a black background to improve visibility under bright conditions. Additionally, in at least one embodiment, the device 21 utilizes 1.8V LEDs but variations as to colors and types of LEDs, as well as other types of indicators are also contemplated.

One should note that in addition to providing feedback on the conductive properties of a test material, data indicators 25, 27 may be configured to indicate remaining battery life. Similarly, a battery indicator can be coupled to the device that can show an approximate level of stored energy in the. Other, similar indicating components may also be employed.

The device 21 can additionally be configured to activate instantaneously when the probe 39 is immersed into a test material. Embodiments of the device 21 may also be used to indicate the presence or absence of an aqueous ion-containing solution. When properly positioned, the device 21 can also be used to detect flooding or changes in water levels. As a non-limiting example, the water purification determination device 21 can be placed in a rain gauge such that after a certain amount of rainfall has been accumulated in the probe 39 can contact the rainwater, thereby activating the circuitry of the device 21. A signal indicating activation of the circuitry can then be communicated to the user.

FIG. 2 is an exemplary circuit diagram illustrating one embodiment of logic that can be incorporated with the water purification determination device from FIG. 1. As illustrated in the depiction of circuit 55, power source 35 can include a battery. Alternatively (or supplementally), the power source 35 can be configured for connection with an external power source such as a wall outlet, solar panel, and/or other power source. As is evident to one of ordinary skill in the art, a combination of battery power, such as a rechargeable battery and external power can be utilized for recharging the battery 35. Alternatively, the device can be configured to operate without using a battery 35 at all. Additionally, the device 21 can have a power saving feature such as power switch 33 or a timing device that can deactivate the device after a certain time of inactivity.

In this exemplary non-limiting embodiment of FIG. 2, potentiometer 37 is a 100 kilo-ohm (KΩ) rated potentiometer, but depending on the particular configuration of circuit 55, this is not a requirement. Additionally, the resistor 53 can be a 1000 ohm rated resistor (1KΩ), however this is not a requirement. Coupled to the diode 27 and resistor 53 is a bypass resistor 49. In at least one embodiment the bypass resistor 49 is a 22 KΩ resistor. Coupled to the bypass resistor 49 are the first data indicator 25 and a current limiting resistor 51. As discussed with the second data indicator 27, the first data indicator may or may not be an LED. Also included in the circuit diagram of FIG. 2 is a jack 39 that serves as a probe. Jack 39 has a probe sleeve 43, which may serve as a second electrode and a probe tip 41, which may serve as a first electrode. The first and second electrodes 41, 43 may work concurrently to provide various readings to a user.

The first electrode 41 and second electrode 43 can be very rugged and can also act as a connector or adapter (or both) to attach additional measuring devices. Such additional measuring devices can include a probe, an electrode, a detector, an adapter, and extensions with various other types of detectors at the distal terminus. Attachable probes or electrodes may be disposable and may be sterilized by heat sterilization, gas sterilization, chemical sterilization or disinfected by other means to avoid contamination of the solution that is to be tested.

The probe jack 39 can be constructed in a fashion similar to a standard mono and/or stereo phone plug to allow attachment of another device, by means of a standard phone jack or other input/output interface. Hence, any other probe, device, and/or means for detecting any other parameter that produces a change in resistance, or can be made to produce a change in resistance, can also be monitored. As a non-limiting example, a temperature (transducer) probe, a pressure (transducer) probe, a light sensitive (transducer) probe, or any permutation of these or other components can be coupled to the device 21 by attachment to jack 39. One should note that selection of components and component ratings can affect the sensitivity of the device. Depending on the particular use, components of different ratings can be used.

In a supplemental non-limiting example, attachable (snap-on, push on) probes or electrodes may be disposable and can therefore be used for a period of time compatible with the effective life of the probe under the circumstances of use. The probe can then be easily replaced with a new probe. As a non-limiting example, a disposable probe may be attached to probe tip 41 of jack 39.

While the circuit 55 represents the second data indicator 27 as a light emitting diode or (LED), this is also not a requirement. As is evident to one of ordinary skill in the art, any means of indicated data to a user may be used. At least one non-limiting example includes using a plurality of meters that indicate a probe value and an adjustable value. Readings from the meters can be matched to acquire the impurity concentration, similar to matching LED luminous intensity. As an additional non-limiting example, the data indicators 25, 27 can include a plurality of sound devices. The probe sound device can emit a sound of a particular tone or volume, and a user can try to match the tone or volume with the sound emitted by the adjustable sound device.

In operation, the non-conducting portion 42 of the probe 39 can be configured to separate the first electrode 41 on the probe from the second electrode of the probe 43. When a conductor bridges this non-conducting region, such as salt water (which contains dissolved ions), current can flow from the first electrode 41 to the second electrode 43. The amount of current can be proportional to the conductivity of the solution and inversely proportional to the resistivity of the solution. The higher the ion concentration in the aqueous solution, the greater the amount of current that bridges to the second electrode.

The second electrode on the probe jack 39 can then make a connection to a current limiting resistor 51 then to one terminal of the probe data indicator 25 (for example, probe LED). The second terminal of the probe LED 25 can make a connection to the negative terminal of the battery 35. As current flow through the circuit increases, the probe LED's luminous intensity (brightness) increases. Thus, as resistance in the aqueous solution decreases due to increases in ion concentrations, the probe LED 25 becomes brighter. More specifically, as the concentration of contaminants in the water increase, probe LED 25 becomes brighter.

Current to the adjustable data indicator 27 flows from the positive terminal of the power supply 35, to one terminal of the adjustable resistance potentiometer 37. As current leaves the sweeper terminal of the potentiometer 37, it passes through a current limiting resistor 53, then through the adjustable data indicator 27, and the circuit is completed to the negative terminal of the power supply 35.

A bypass resistor 49 can be configured to adjust the resistance across the adjustable data indicator 27. As the resistance of the potentiometer 37 is decreased, more current flows to the adjustable data indicator 27 and its output changes. At any given resistance setting for the potentiometer, the potentiometer knob 29, used to adjust the resistance, points to a specific number of the circular arrangement of numerals around the knob. Thus a specific number can be assigned to a specific resistance and a specific data indicator output, such as LED luminous intensity.

As a non-limiting example, a calibrated dial can also include a calibrated dial. The calibrated dial can include an array of values. The values can correspond to data in a table that the user can refer to determine the impurity concentration. Alternatively, in at least one embodiment, the calibrated dial can provide the impurity concentration direction.

When a user is testing a test material, the conductivity of the test material can activate the probe data indicator 25. The user can then adjust the potentiometer 37 such that the adjustable data indicator 27 outputs a signal of similar intensity as the probe data indicator 25. The user can then determine an impurity concentration value from the position of the potentiometer knob 29.

In another non-limiting example, a user can insert the probe jack 39 into a desired test material. Based on the conductivity of the test material, electrical communication between the first electrode 41 and the second electrode 43 can facilitate activation of the probe indicator 25. Assuming that the data indicators 25, 27 take the form of two LEDs, the first LED 25 can be considered the probe LED, while the second LED 27 can be considered the adjustable LED. To determine the conductivity, and therefore the impurity concentration of the test material, the potentiometer knob 29 can be adjusted such that the luminous intensity of the adjustable LED 27 the intensity of the probe LED 25. A numerical value can then be read from the disclosure. This can provide values for subsequent comparison or to otherwise assist in observing and evaluating changes in those parameters.

Another embodiment of the present disclosure could take advantage of the ability to move the probe jack 39 great distances from the device 21. This may enable a user to lower the probe into a deep well and taking the measurements at the well head. Such a configuration could include a probe 39 that is coupled with a transmitter configured to transmit the conductivity data to the device 21. Such a transmitter could include a radio frequency (RF) transmitter, or other similar means for communicating data wirelessly over a predefined distance or distance range. Depending on the particular configuration, the probe 39 (and coupled transmitter) may utilize enough power to warrant an additional power source.

Remote operation of the device 21 can also be utilized via a wired connection with the measurement device 21. In this non-limiting example, the jack 39 can be connected to an extension cable that can terminate at the other end with a plug. The jack can act as a probe or connector (or both) at that end of the cable. Such a configuration can allow the probe to be located distally from the device 21 and allow readings to be taken when the aqueous solution is located remotely from the device 21. This can allow for operation of the device in or near a well such that when the water level in the well reaches a predetermined level, the device 21 makes contact with water.

Additionally, at least a portion of the device being installed in a plumbing system can provide a user with automatic feedback regarding the water quality of the user's tap water. A similar configuration can take place at the intake or entry point into a building. Other embodiments may include the probe being placed in a fixed position in a precipitation-gathering device, which is collecting precipitation. This configuration can alert the user that the water has reached a certain level in the rain gauge or water gathering device, indicating that a rainfall event of a given magnitude has occurred.

On a similar note, the probe 39 can be configured for positioning in a sump area, drainage ditch, flood prone area, basement, or any area where water may be absent but where rising water levels might be undesirable. If the probe is positioned at a level where water damage may occur, a change in conductivity can cause a change in the illumination of the probe data indicator 25 to warn of the rising water levels.

FIG. 3 is a flowchart diagram illustrating a process that a user may take in operating the device from FIG. 1. As illustrated, the first block in this non-limiting example is to immerse the probe in a test material (block 332). As described above, the test material can include water, or other material that a user could desire the electrical conductivity information. Next, the user can activate the device (block 334). The device can be activated by changing the position of the power switch 33 (FIG. 1), or other means of activation. In at least one non-limiting example, activation may occur by simply placing the probe in the test material. The next block in this non-limiting example is to turn the knob (FIG. 1, element 29) until the data indicators match in luminous intensity (block 336). As discussed above, the data indicators used may include two LEDs, but this is just a non-limiting example. The user can then read the number opposite the knob marker to determine the desired information (block 338).

While at least one embodiment of the present disclosure automatically resets the data indicators, other embodiments may be configured to hold the last reading, until a reset operation is activated. In such a scenario, the user can determine the highest, lowest, and/or average reading for a given test material. Additionally, as is evident to one of ordinary skill in the art, supplemental logic may be included with the device 21 to allow various data calculations and operations to be performed. Similarly, the device may also be configured to communicate with a network or other external logic, such as a personal computer, cell phone, PDA, etc. In this non-limiting example, various data computations and storage can be communicated to and from the device 21.

Alternatively (or supplementally), the user can refer to a chart provided with the device to determine actual values for total dissolved solids in the solution. The chart can be configured to provide a list of numerical values and the corresponding total dissolved solid concentrations, based on prior testing using a similar device under defined conditions and previously conducted in the laboratory. Likewise, another chart, also obtained by repeatable experiments, can be configured to allow for direct conversion of numerical values to specific resistance values and to specific values of ion concentrations in the solution.

One should note that, even without the charts, changes can be measured by simply recording the numerical values obtained at one sampling time and comparing them to the value obtained at the next sampling time. If the numbers are different, then a significant change has occurred in contaminant levels. If the numbers are the same, then no significant change has occurred in contaminant levels.

In another non-limiting example, instead of utilizing LEDs as the only data indicator, the device may include logic and a display for making the conversions discussed above. In this embodiment, conversions may be automatically displayed to the user.

Additionally, the device 21 can be incorporated with water purification systems to allow for automatic purification of water based on readings received from the device. As a non-limiting example, the device can be configured to provide a water quality monitor for use in connection with water softening equipment that is capable of removing or adding various ions.

FIG. 4 is a graphical diagram describing an embodiment of a relationship between the reading on the water purification system and the resistance across the probe of the water purification system from FIG. 1. In the nonlimiting example of FIG. 4, readings on the water purification system are plotted on the y-axis, while probe resistance is plotted on the x-axis. As illustrated in this embodiment, there is a substantially linear relationship between readings on the water purification system and resistance across probes of the water purification system.

FIG. 5 is a graphical diagram illustrating a relationship between Total Dissolved Solids (TDS) and resistance of a sample, similar to the diagram from FIG. 4. More specifically, as illustrated in FIG. 5, TDS is plotted on the y-axis with resistance in kilo-ohms is plotted on the x-axis. As the graph of FIG. 5 illustrates, in at least one embodiment, there is a substantially inverse relationship between the TDS of a sample, compared with the sample's resistance.

When taken together with the graph from FIG. 5, which describes the relationship between Total Dissolved Solids (TDS) and resistance in kilo-ohms one can see that readings from the water purification system can be translated directly into TDS readings.

Also, these values can be presented in tabular form as shown in Table 1.

TABLE 1

| Resistance | Device |
|---|---|
| in Kohms | Reading |
| 5 | 54.3 |
| 10 | 53.3 |
| 20 | 51.4 |
| 30 | 49.5 |
| 40 | 47.6 |
| 50 | 45.6 |
| 60 | 43.7 |
| 70 | 41.8 |
| 80 | 39.9 |
| 90 | 38.0 |
| 100 | 36.1 |
| 125 | 31.3 |
| 150 | 26.5 |

One should also note that in at least one embodiment, the water purification system can be configured to automatically determine the current and/or voltage communicated to the first LED. As a nonlimiting example, the water purification system can be configured to include a display (e.g., liquid crystal display) for providing this information to a user. Additionally, other embodiments can be configured to automatically adjust the potentiometer until the voltage and/or current through the second LED matches the voltage and/or current through the first LED.

Additionally, embodiments can be configured with predefined settings for various test materials, such as water, vinegar, hydrochloric acid, etc. Logic could be included in the device to account for the test material and determine the purity based on that setting (e.g., distilled water has different electrical properties than vinegar. The device could account for this difference to determine if the test material is pure vinegar. Similarly, at least one embodiment can be configured to determine the type of impurity being detected. As different impurities can have different ionic properties, these properties can be detected by the water purification system.

It should be emphasized that many variations and modifications may be made to the above-described embodiments. All such modifications and variations are intended to be included herein within the scope of this disclosure and protected by the following claims.

Therefore, at least the following is claimed:

1. A device for monitoring a test material, comprising:
a probe configured for introduction to the test material, the probe including a first electrode and a second electrode, the first electrode being positioned a predetermined distance from the second electrode;
a power source configured to provide a current to the probe;
a first data indicator configured to communicate data related to at least one electrical property of the test material to a user; and
a potentiometer configured with a user input device, the user input device being configured to facilitate adjustment of the potentiometer in response to receiving data from the first data indicator.

2. The device of claim 1, further comprising a second data indicator coupled to the potentiometer, the second data indicator being configured to provide information related to at least one electrical property of the test material and to further provide information related to the potentiometer.

3. The device of claim 1, wherein the data indicator includes at least one Light Emitting Diode (LED).

4. The device of claim 1, wherein the power source includes at least one of the following: a battery and an external power source.

5. The device of claim 1, wherein the device is configured for remote operation via wireless communication between the data indicator and the probe.

6. The device of claim 1, further comprising logic configured to convert at least a portion of the data related to at least one electrical property of the test material into data related to at least one impurity.

7. The device of claim 1, further comprising logic configured to store at least a portion of the data related to the at least one electrical property of the test material.

8. A method for testing the purity of a test material, comprising:
introducing a probe to the test material, wherein the probe includes a first electrode and a second electrode the first and second electrodes separated by a predetermined distance;
facilitating the introduction of an electrical current to the probe;
receiving first data related to at least one electrical property of test material;
receiving second data related to at least one electrical property of the test material;
adjusting at least one electrical property of a potentiometer, wherein the potentiometer is coupled to the probe until the second data roughly equals the first data; and
determining at least one electrical property of the test material.

9. The method of claim 8, further comprising receiving data related to the at least one electrical property of the test material and converting the data into data related to least one impurity.

10. The method of claim 8, wherein the data related to the at least one electrical property of the test material includes data provided by a Light Emitting Diode (LED).

11. The method of claim 8, wherein the test material includes water.

12. A system for determining impurities in a test material, comprising:
an electrical property collector configured to receive at least one electrical property related to the test material;
a first data indicator configured to provide a user with at least a portion of the data received from the electrical property collector;
a second data indicator;
an impurity input device coupled to the second data indicator, the impurity input device configured to adjust data provided by the second data indicator via a user input; and
an impurity output device coupled to the impurity input device, the impurity output device configured to display data related to at least one impurity in the test material.

13. The system of claim 12, wherein the electrical property collector includes a first electrode and a second electrode, wherein the first electrode and the second electrode are spaced a predetermined distance apart.

14. The system of claim 13, wherein the electrical property collector further includes a non-conductive portion separating the first electrode and the second electrode.

15. The system of claim 12, wherein the first data indicator is a visual data indicator.

16. The system of claim 15, wherein the first data indicator includes at least one of the following: a Light Emitting Diode (LED) and a meter display.

17. The system of claim 12, wherein the second data indicator is a visual data indicator.

18. The system of claim 17, wherein the second data indicator includes at least one of the following: a Light Emitting Diode (LED) and a meter display.

19. The system of claim 12, wherein the system includes a potentiometer.

20. The system of claim 12, wherein the impurity input device includes a user adjustable knob configured for user adjustment.

21. The device of claim 1, wherein the probe is comprised of a phone plug, a power plug or a stereo phone plug or jack, and wherein optionally at least a portion of the probe is disposable.

22. The method of claim 8, wherein the probe is comprised of a phone plug, a power plug or a stereo phone plug or jack, and wherein optionally at least a portion of the probe is disposable.

23. The system of claim 12, wherein the electrical property connector is comprised of a phone plug, a power plug or a stereo phone plug or jack, and wherein optionally at least a portion of the probe is disposable.
